(19) United States
(12) Patent Application Publication
(10) Pub. No.: US 2007/0288223 A1
(43) Pub. Date: Dec. 13, 2007

(54) Method, Device and Software Module for a Software-Engineered Reproduction of the Behavior of an Actual Domestic Appliance in a Model

(76) Inventors: Horst Werkmann, Pfaffenhofen/Ilm (DE); Michael Ellinger, Matzen (AT); Hans Haugeneder, Geratskirchen (DE)

Correspondence Address: LERNER GREENBERG STEMER LLP, P O BOX 2480, HOLLYWOOD, FL, 33022-2480, US

(21) Appl. No.: 11/661,004

(22) PCT Filed: Aug. 4, 2005
(86) PCT No.: PCT/EP05/53825

§ 371 Date: Jul. 3, 2007

(30) Foreign Application Priority Data
Aug. 23, 2004 (DE) 10 2004 040 795.9

(51) Int. Cl. G06F 9/45

(52) U.S. Cl. 703/22

(57) ABSTRACT

A method for a software-engineered reproduction of the behavior of an actual domestic appliance in a model, which is connected to the domestic appliance via a bi-directional connecting device, by which current states of the relevant domestic appliance are transmitted to the model and actions are executed on the domestic appliance. The model is merely described declaratively by way of graph structures with regard to the appliance parameters which indicate the appliance behavior. Appliance states and transition conditions between appliance states of the relevant domestic appliance are retained in a status graph software and it is checked by means of a control graph software whether a specific action can be executed in the respective appliance state of the relevant domestic appliance or with specified parameter combinations. An appliance information software contains all the information on the available status variables and actions of the relevant domestic appliance.

The invention relates to a method for a software-engineered reproduction of the behavior of an actual domestic appliance in a model which is connected to the relevant domestic appliance via a bidirectional connecting device, the latter being used to transmit the current states of the relevant domestic appliance to the model and to execute actions in the domestic appliance.

The present invention further relates to a device for a software-engineered reproduction of the behavior of a real domestic appliance in a model which is formed between the relevant domestic appliance and a gateway to which a plurality of domestic appliances optionally belong and via which function states of the respective domestic appliance can be interrogated and/or information data can be transmitted to the respective domestic appliance.

The present invention also relates to a software module for a software-engineered reproduction of the behavior of an actual domestic appliance in a model which can be connected to the relevant domestic appliance via a bidirectional connecting device via which current states of the relevant domestic appliance can be transmitted to the model and actions can be executed in the domestic appliance.

A method for monitoring a plant consisting of a plurality of sub-systems is known (U.S. Pat. No. 6,587,737-B2). For this purpose, various measured values of the plant are detected for a fixed set of process parameters at pre-settable time intervals during the operation of the plant. The measured values determined in a learning phase are used to prepare models for the operating characteristics of the relevant sub-systems. The real measured values are then compared with the relevant models, that is, the function parameters of the real plant are compared with the parameters recorded in the models in order to ascertain any deviations between these parameters. However, nothing is known about the preparation of models of the behavior of a real appliance in this connection.

A method for computer-assisted generation of a graphical user interface and an equipment monitoring/control unit are further known (DE 102 08 146 A1). This method and the relevant equipment monitoring/control unit can be used to monitor and/or control a plurality of equipment in a simple manner using conventional browser technology. The relevant method and said equipment monitoring/control unit is implemented in a building gateway in which an image of the relevant real equipment world is created. Among other things, the XML format is used for the description of the base structures. The image of the relevant real equipment world created in the building gateway however, is not a reproduction of the appliance behavior of the relevant appliance world.

In addition, a building gateway computer arrangement and a control system are known (DE 10 08 147 A1) are known, that is equipment used in the previously considered known method and in the previously considered known equipment monitoring/control unit. In this case also, the relevant equipment is implemented in a building gateway in which only an image of the relevant appliance world is created but not a reproduction of the appliance behavior of the relevant appliance world.

Finally, a device and a method for creating a virtual installation model are also known (EP 1 092 210 B1). The background of the relevant device and the relevant method is the circumstance that the case is frequently encountered in practice that a real installation does not agree with the original plans of the installation since special adaptations or retrofitting have already been carried out when creating the installation or its plans do not contain the information required for the data-engineering further processing. Thus, a coupling of a virtual installation model to the real installation is made in such a manner that a virtual installation 2 is used not only for a static visualization and documentation of an installation 1 but it can additionally take over a plurality of real functions relating to information, operation and observation of the real installation. In this case, also nothing is specifically known about a reproduction of the behavior of a real installation in a model.

It is the object of the invention to show a way in which a software-engineered reproduction of the behavior of a real domestic appliance can be made in a model which can also be implemented by non-software developers and can easily be modified.

The object indicated hereinbefore is achieved in a method of the type specified initially according to the invention whereby said model is merely described declaratively with regard to the appliance parameters which indicate the appliance behavior.

The declarative description of appliance parameters specifying the appliance behavior in said model thus describes the relationship between the units determining the relevant appliance behavior in the real world. In other words, this means that the relevant declarative description of the appliance behavior of a real domestic appliance or of the appliance parameters specifying the appliance behavior effects an abstraction, which takes place independently of computers used in each case in the domestic appliances, so that this image of the appliance behavior can support the use of any computers. In addition, as a result of the declarative description of the appliance behavior of the respective real domestic appliance or the parameters specifying the relevant appliance behavior, such a description can easily be executed by non-software developers and can easily be modified since no special software engineering expertise is required. In addition, the declarative description of the appliance behavior of the respective real domestic appliance or the parameters specifying the relevant appliance behavior can be checked relatively simply for syntactic accuracy.

The declarative description of said model preferably uses graph structures. This has the advantage of a particularly simple description of the relevant model.

Appliance states and transition conditions between appliance states of the relevant domestic appliance are appropriately retained in status graph software. Such software advantageously makes it possible to check whether a specific action can be executed in the respective appliance state of the relevant domestic appliance or with specified parameter combinations and said software contains all the information on the available status variables and actions of the respective domestic appliance.

This results in the advantage that it is particularly simple to check the executability of specific actions in the respective state of a domestic appliance.

The software-engineered reproduction is preferably implemented by appliance-specific components and by specifications which describe the functional properties and therefore the appliance behavior of the relevant domestic appliance under various aspects. This has the advantage that a description of the appliance behavior of the respective real domestic appliance and therefore of the appliance parameters specifying the respective appliance behavior which can be used virtually comprehensively is available.

Links (logic) of the appliance control of the relevant domestic appliance are appropriately imaged by means of said specifications. This has the advantage that the appliance behavior of the respective domestic appliance can be described and checked particularly simply.

The object of the invention specified above can further be achieved in a device of the type specified initially according to the invention in that said model is merely described declaratively with regard to the appliance parameters which indicate the appliance behavior and is constructed from a software component to said gateway and by a software component to the respective domestic appliance as well as by a specification data component between the two software components. This has the advantage of a particularly simply structured model configuration.

Said specification data components preferably comprise a control graph software component, an appliance information component and a state graph software component. This classification of the specification data components brings with it the advantage of a particularly simple systematic classification and detection of the relevant individual components.

In addition, the object specified above is achieved by a software module for a software-engineered reproduction of the behavior of an actual domestic appliance in a model which can be connected to the relevant domestic appliance via a bi-directional connecting device by means of which current states of the relevant domestic appliance can be transmitted to the model and actions can be executed in the domestic appliance which is characterized according to the invention in that said model is merely described declaratively with regard to the appliance parameters which indicate the appliance behavior. This has the advantage of a particularly simply structured model.

Appropriate further developments of the software model according to the invention are covered in claims 10 to 14.

An exemplary embodiment of the present invention is explained in detail hereinafter with reference to a drawing.

Shown schematically in the drawing is a residential complex WA which can comprise a single dwelling or a plurality of dwellings or a house; at least one networkable domestic appliance HG is located in this residential complex. The relevant domestic appliance HG can be any networkable domestic appliances, such as a washing machine, a drier, a cooker, a refrigerator, a heating system etc. A networkable domestic appliance is understood here as a domestic appliance which can be transmitted by means of a transmitting and/or receiving device to a communication network NET for transmitting various data signals. In the present case, this communication network NET comprises the internet, for example. Naturally however, any other network such as the mains AC network from which the supply voltages required for operation of the respective domestic appliance are taken can be used as the communication network.

In the drawing, however, a branching symbol associated with the domestic appliance HG indicates that a plurality of domestic appliances HG can pertain to the relevant residential dwelling WA.

In the present case, a bidirectional connecting device is connected to the domestic appliance HG or to the multiplicity of domestic appliances provided, said connecting device being formed by a software module SWM in which, as will be described in detail, the model of the appliance behavior of the respective domestic appliance HG will be or is declaratively described with regard to the parameters specifying the appliance behavior. In the present case, the relevant software module SWM is connected to a gateway GW, that is to a transition interface device of the residential complex WA. This gateway GW can be provided as a plurality of gateways as is indicated by the branching symbol indicated in the drawing. The relevant gateways are connected via bidirectional connecting paths to connecting networks via which information data such as updated operating programs can be transmitted to and from the individual domestic appliances and status requests can be made, for example in the course of remote diagnoses. In the present case, the gateway GW shown in the drawing is connected to the afore-mentioned communication network NET which can comprise the internet for example; however, as has already been mentioned, the relevant network NET can also be formed by the power supply network from which the respective household appliance HG takes its energy. The network NET shown in the drawing is connected to a personal computer PC which, for example, can serve as a remote diagnostic station and/or as a loading station from which remote requests can be made at the respective domestic appliance or updated operating programs can be transmitted to the respective domestic appliance HG.

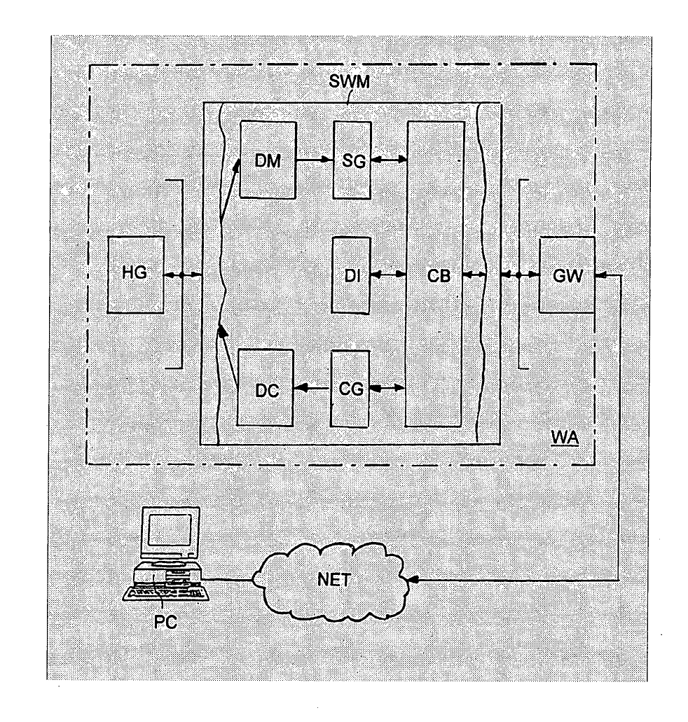

Since the basic structure of the device shown in FIG. 1 has been explained previously, the detailed structure of the aforesaid software module SWM is now considered. As can be seen from the drawing, this software module SWM is divided into three software levels. The level to the respective domestic appliance HG comprises a software component which consists of an appliance model software DM in the connecting direction away from the respective domestic appliance HG and an device control software DC towards the respective domestic appliance HG. The tasks and operating modes of these software modules will be described in further detail hereinafter.

On the side of the respective gateway GW the software module SWM has a control unit architecture bridge CB which is in bidirectional communication with the respective gateway GW. The tasks and functions of this control unit architecture bridge CB will be explained in further detail hereinafter.

Located between the software modules considered hereinbefore on the side of the respective domestic appliance HG on the one hand and on the side of the respective gateway GW on the other hand, as shown in the drawing, are specification data components or modules which comprise an appliance information component DI and a state graph software component SG. The tasks and functions of these software components will also become clear in detail from the following description. In this case, the operative connections fundamentally decisive for the present invention are indicated between the individual software components by arrows which however do not exclude further operative connections in the software module SWM shown in the drawing.

Data transmitted by the respective relevant domestic appliance such as the domestic appliance HG are evaluated and stored in the appliance model software model DM. The relevant data are then checked by means of the state graph software component SG as to whether they are consistent.

The possible states of the relevant respective domestic appliance and their transition conditions are specified in the state graph software component SG. In the event of a deviation from state graphs, various correction measures can be introduced, e.g. a re-synchronization with the respective domestic appliance by reading out all the relevant appliance states. The state graphs are preferably written in XML and they contain the elements described in the following Table 1.

TABLE 1

| | XML Syntax | Description |
|---|---|---|
| 1 | Start | |
| 1.1 | <graph> | Beginning of the state graph |
| 2 | States | |
| 2.1 | <state> | The state of the superordinate element comprises appliance |
| | <condition></condition> | states for nodes. The state element has a mandatory attribute |
| | <target></target> | ID which describes the name of the state. A state element |
| | ... | has zero or more subordinate target elements. |
| | <target></target> | |
| | </state> | |
| 2.2 | <target> | The subordinate target element is contained in a state |
| | ‘...’ | element and it describes a state which can be achieved by its |
| | </target> | superordinate element. |
| 2.3 | <trigger_statevars> | The trigger state which changes the subordinate element is |
| | <sv></sv> | contained in the graph element and it describes all state |
| | ... | variables which can trigger a change in the state of the |
| | <sv></sv> | appliance. The single trigger state variable “DeviceState” is |
| | </trigger_statevars> | usual. |
| 3 | simple states | |
| 3.1 | <condition> | This is the same structure as in the appliance control file (see |
| | </condition> | 6. in the control graph syntax specification) |
| 4 | End | |
| 4.1 | </graph> | End of the state graph |

An example in connection with a baking oven is given briefly hereinafter. The definition for the appliance state OFF is given: the appliance status object must have the value 1; the following states can be standby, running and inert.

```
<state name = “off”>
  <condition>
    <set statevar = “deviceState”>
      <value>1</value>
    </set>
  </condition>
  <target>stand-by</target>
  <target>running</target>
  <target>inert</target>
</state>
```

The device control software component DC is used to convert function calls of higher layers of the protocol used into corresponding EHS commands. These EHS commands comprise those of the European Home System Standard (EHS standard). In this case, a function call in the device control software component DC can have the effect that a plurality of EHS commands are transmitted. These commands are executed as transactions.

The device control software component DC further comprises virtual functions which have no direct effects on the respective real domestic appliance. The respective values are held in the gateway GW and if required are transmitted collectively to the respective domestic appliance. For example, a washing parameter input to a washing machine can only be made, for example, when the washing program is started in the relevant washing machine.

In the control graph software component CG it can be checked whether a specific action can be executed in the respective domestic appliance state or with the specified parameter combination. The control graphs are written in XML and they contain the elements described in the following Table 2.

TABLE 2

| | XML Syntax | Description |
|---|---|---|
| 1 | Start | |
| 1.1 | <control> | Start of appliance control |
| 2 | Executions | |
| 2.1 | <quotes> | A state or a conditions can be used several times in an XML |
| | <condition> | file. In this case, it can be described once in the execute |
| | </condition> | element and then quoted with the quoted attribute which |
| | ... | merely yields its ID. This shortens the object generation and |
| | <condition> | parsing time. |
| | </condition> | |
| | </quotes> | |
| 3 | States | |
| 3.1 | <state> | The superordinate state element has a mandatory attribute |
| | <allowedaction> | ID which describes the name of the state. State IDs must be |
| | </allowedaction> | the same in the appliance graph file and in the appliance |
| | ... | control file. A state element has zero or a plurality of allowed |
| | <allowedaction> | action or allowed subordinate wizard elements. A state |
| | </allowedaction> | element can be a subordinate of a control or column |
| | <allowedwizard> | element. See the description of this last case. |
| | </allowedwizard> | |
| | <allowedwizard> | |
| | </allowedwizard> | |
| | </state> | |
| 4 | Wizards | |
| 4.1 | <wizard> | The superordinate wizard element has a mandatory attribute |
| | <condstruct> | ID which is used in the allowed wizard element to designate |
| | </condstruct> | a specifically available wizard. A wizard element has exactly |
| | </wizard> | one structure? subordinate element. |
| 4.2 | <allowedwizard> | The allowed superordinate wizard element contains a |
| | ‘...’ | sequence which must be an ID of a wizard. This element is |
| | </allowedwizard> | contained in a state element and defines a wizard which can |
| | | be input in the relevant appliance state. |
| 5 | Actions | |
| 5.1 | <action> | The superordinate action element has a mandatory attribute |
| | <condition> | ID which describes the ID of the action. Action IDs must be |
| | </condition> | the same in the metadata file and in the appliance control |
| | </action> | file. An action element can contain a subordinate state or |
| | | condition element relevant to it. The state or the condition |
| | | specifies when the action can be requested for the present |
| | | state (the superordinate element). |
| 5.2 | <arg> | The argument of the superordinate element, its content type, |
| | <set><set> | can be specified as a range or constant. The semantic of the |
| | or | element lies in the fact that the given argument can merely |
| | <range></range> | take on the values described in its superordinate element. It |
| | | has a mandatory attribute ID which designates a unique |
| | | identification for the argument. The IDs of the corresponding |
| | | arguments of the actions must be the same in the metadata |
| | | XML and the appliance control XML. |
| 5.3 | <allowedaction> | The allowed superordinate action element contains a |
| | ‘...’ | sequence which must be an ID of an action. Action IDs must |
| | </allowedaction> | be the same in the metadata file and in the appliance control |
| | | file. This element is contained in a state element and defines |
| | | an action which can be requested in the relevant appliance |
| | | state from a remote location. |
| 6 | Simple | |
| | states/conditions | |
| 6.1 | <condition> | The state or the condition of the superordinate element is |
| | <and></and> | formed by applying a logical “or” or a logical “and” to two or |
| | or | more Boolean terms. A state or a condition can contain |
| | <or></or> | precisely one single term. In this case, the condition is |
| | or | satisfied if the term contains the value “true”. A term can be |
| | <expr></expr> | an expression, a range or a set condition. |
| | or | |
| | <range></range> | |
| | or | |
| | <set></set> | |
| | </condition> | |
| 7 | Conditional structures | |
| 7.1 | <condstruct> | The conditional superordinate structure element is formed |
| | <column></column> | by a number of logic columns of which each one either |
| | ... | represents an action with an argument of a state-variable |
| | <column></column> | range/value/set/expression. The cycle element describes a |
| | <cycle></cycle> | valid path through the column elements. |
| | ... | |
| | <cycle></cycle> | |
| | </condstruct> | |
| 7.2 | <column> | The superodinate column element, the respective element in |
| | <domain></domain> | the column, describes a set of allowed or permissible values |
| | <state></state> | for an action or a state variable. This set is represented by a |
| | ... | state element. All elements in a column describe the same |
| | <state></state> | action with the argument or the state variable. Each state in |
| | </column> | the column has a mandatory attribute ID which is used in the |
| | | description of the valid sets of states for the conditional |
| | | structure in the cycle element. The column element has a |
| | | mandatory attribute: ID. This must be the ID of an action or |
| | | an attribute. Action IDs and argument IDs must be the same |
| | | in the metadata file and in the appliance control file. |
| 7.3 | <cycle> | The superordinate cycle element contains a set. The set |
| | <set></set> | element must contain a valid sequence of actions and/or |
| | </cycle> | conditions of the state variables within the conditional |
| | | structure. The states in the cycle can be run through in any |
| | | sequence and each of the relevant states can be skipped. |
| 7.4 | <state> | The states within a column are logic states. Each state |
| | ... | represents a value range for the state variable or the input |
| | </state> | argument of the column of which it is a member. |
| 8 | Expressions | |
| 8.1 | <domain> | The superordinate range element: a range designates a |
| | <id></id> | reference for the value of a state variable or an action input |
| | <actionid> | argument. Whether it is a reference for a state variable or an |
| | </actionid> | input argument is obtained from the type attribute (Type = “sv”\| |
| | </domain> | “arg”). If the type is “sv”, the ID element must contain |
| | | the ID of the reference state variable. The action ID element |
| | | is omitted. If the type is given with “arg”, the ID element must |
| | | contain the ID of the reference input argument and the |
| | | action ID must contain the ID of the relevant action. |
| 8.2 | <expr> | The superordinate expression element consists of two |
| | <domain></domain> | elements: domains and (domain or constant). A domain |
| | <domain></domain> | designates a reference for the value of a state variable or an |
| | or | action argument. A constant represents a value. The two |
| | <const></const> | parts of the expression can be considered as two operands |
| | </expr> | of a comparison operator. The operator type is deduced |
| | | from the “operator” attribute. It has one of the following |
| | | values: gt-greater, ge-greater or equal to, Is-less than, le- |
| | | less than or equal to, eq-equal to, ne-not equal to. |
| 8.3 | <sv>”name”</sv> | The state variable element whose content type is given with |
| | | #PCDATA. The IDs of the state variables must be the same |
| | | in the metadata file and in the appliance control file. |
| 8.4 | <const>”value”</const> | The constant element whose content type is given by |
| | | #PCDATA must contain a value which is parsable by the |
| | | standard Java classes. The other operand type determines |
| | | the type of value: the state variable of the input argument. |
| 9 | Value ranges | |
| 9.1 | <range> | A value range which is described by a minimum value, a |
| | <min>”...”</min> | maximum value and a step value. For example, min = 10, |
| | <max>”...”</max> | max = 60, step = 10 here defines {10, 20, 30, 40, 50, 60}. |
| | <step>”...”</step> | |
| | </range> | |
| 9.2 | <set> | Defines a value set |
| | <el></el> | |
| | ... | |
| | <el></el> | |
| | </set> | |
| 9.3 | <value> | Defines a single value |
| | “value” | |
| | </value> | |
| 10 | End | |
| 10.1 | </control> | End of appliance control |

An example for a baking oven is given hereinafter. The allowed functions for appliance status are given by standby and inert.

<state id = “stand-by”>

<allowedaction id = “set InertOven0”/>
<allowedaction id = “set InertCooker0”/>
<allowedaction id = “set DeviceName”/>
<allowedaction id = “set Language0”/>
<allowedaction id = “set RealTimeClock0”/>
<allowedaction id = “set HeatingMode”/>
<allowedaction id = “set HeatingModeCompleted0 “/>
<allowedaction id = “set Temperature“/>
<allowedaction id = “set Duration“/>
<allowedaction id = “set DurationWAP“/>
<allowedaction id = “set FinishTime“/>
<allowedaction id = “set FinishTimeWAP“/>
<allowedaction id = “set BasicSettings0“/>
<allowedaction id = “set ChildProofLock0“/>
<allowedaction id = “set HobDeviceName“/>
<allowedaction id = “set ClockPresentation0“/>
<allowedaction id = “set AdjustDuration0“/>
<allowedaction id = “set AcousticSignalDuration0“/>
<allowedaction id = “fullWizard“/>
</state>

<state id = “inert”>

<allowedaction id = “set DeviceName“/>
<allowedaction id = “set HobDeviceName“/>
<allowedaction id = “set InterCooker0“/>

</state>

An example is now given for an oven; the rule which defines when action “reduceTempLevels” can be executed applies

Rule:

if argument “settingA” of action “reduceTempLevels0” is less than the value of status variable “targetSetting” AND status variable “Heating Mode” is equal to the values 7,8 or 9.

```
<action id = “reduceTempLevels0”>
  <condition>
    <and>
    <expr operator = “ls”>
      <domain type = “arg”>
        <id>settingA</id>
        <actionid>reduceTempLevels0</actionid>
      </domain>
      <domain type = “sv”>
        <id>targetSetting</id>
      </domain>
    </expr>
    <set>
      <domain type = “sv”>
        <id>heatingMode</id>
      </domain>
      <el>7</el>
      <el>8</el>
      <el>9</el>
    </set>
    </and>
  </condition>
</action>
```

The control unit architecture bridge CB will be discussed hereinafter, which plays a central role in the respective software-engineered reproduction of the gateway behavior of a real domestic appliance, such as the domestic appliance HG for the gateway GW. The relevant control unit architecture bridge CB also makes available the functions of the respective domestic appliance in abstracted form, that is independent of the EHS protocol of other services on the gateway GW.

The functions of the respective domestic appliances, such as the domestic appliance HG, are divided into “StatusVariable” and “Actions”. A status variable comprises a specific appliance status, e.g., an appliance state (DeviceState), an end time (FinishTime) or a target temperature (TargetTemperature). The respective value can be read out from the relevant memory and can be supplied to a specific interested party in the event of a change in state for the purpose of notification. Domestic appliance events, such as, for example, the ending of a program, are likewise imaged by status variables.

The afore-mentioned actions are understood as functions of the respective domestic appliance which can be executed by the gateway GW such as, for example setting a target temperature (SetTargetTemperature) and beginning of operation (Start). An action can require parameters and it reports back whether it could be successfully completed or not.

The control unit architecture bridge CB uses the file of the device information component DI and makes available the information contained therein such as, for example, a range of values and the type of status variables or parameters etc.

Finally, the aforementioned device information component DI should be entered. This component DI contains all the information on available status variables and actions of the respective domestic appliance, such as the domestic appliance HG. In detail, the control graph, also written in XML, contains the elements described in the following table 3.

| | XML syntax | Description |
|---|---|---|
| 1 | Start | |
| 1.1 | <unit> | Start of configuration |
| 2 | CU-information | |
| 2.1 | <name>””name”</name> | Name of control unit |
| 2.2 | <description>”...” | Description information |
| | </description> | |
| 2 | State variable | |
| 2.1 | <statevar> | Defines a state variable. This element has a |
| | | mandatory attribute ID which defines the state |
| | | variable. |
| 2.1.1 | <name>”...”</name> | Defines a name of the state variable |
| 2.1.2 | <description>”...” | Description information |
| | </description> | |
| 2.1.3 | <cardinality>”...” | Defines the cardinality (only one can be used) |
| | </cardinality> | |
| 2.1.4 | <type>”...”</type> | Defines the type: this can be: int, float, char, byte, |
| | | long, short, sequence |
| 2.1.5 | <default>”...” | Defines the default value |
| | </default> | |
| 2A | Allowed values | |
| 2.1.6 | <allowed_values> | Specifies the allowed values of these state variables |
| 2.1.6.1 | <value>”...”</value> | Defines a value. This element has a mandatory |
| | | attribute label which defines the label for this value. |
| 2.1.6.2 | ... | Defines more values ... |
| 2.1.6.3 | ... | |
| 2.1.7 | </allowed_values> | End of allowed values |
| 2B | Value range | |
| 2.1.8 | <min>”...”</min> | Specifies the minimum value of these state variables |
| 2.1.9 | <max>”...”</max> | Specifies the maximum value of these state |
| | | variables |
| 2.1.10 | <step>”...”</step> | Specifies the step of this state variable |
| ... | | |
| 2.1.11 | </statevar> | End of definition of the state variables |
| 3 | Actions | |
| 3.1 | <action> | Defines an action. This element has a mandatory |
| | | attribute ID which defines the action. |
| 3.1.1 | <name>”...”</name> | Defines the name of the action |
| 3.1.2 | <description>”...” | Description information |
| | </description> | |
| 3.1.3 | <input> | Specifies an input argument |
| 3.1.3.1 | <argument> | Specifies the argument. This element has a |
| | | mandatory attribute ID which defines the argument. |
| 3.1.3.1.1 | <name>”...”<name> | Defines a name of the state variable |
| 3.1.3.1.2 | <description>”...” | Description information |
| | </description> | |
| 3.1.3.1.3 | <cardinality>”...” | Defines the cardinality (only one can be used) |
| | </cardinality> | |
| 3.1.3.1.4 | | The remainder of the argument description follows |
| | | the description of the state variables |
| 3.1.3.2 | </argument> | End of argument description |
| 3.1.4 | </input> | End of input of the argument description |
| 3.2 | </action> | End of action description |
| 4 | End | |
| 4.1 | </unit> | end of configuration |

The definition of the status variable “device state” is considered hereinafter for the example of an oven:

```
<statevar id=”deviceState”>
  <name>Device State</name>
  <description>The device state of the Oven</description>
  <type>java.lang.Integer</type>
  <allowed_values>
    <value label=”Off”>1</value>
    <value label=”Stand-By”>2</value>
    <value label=”Programmed”>3</value>
    <value label=”ProgrammedWaitingToStart”>4</value>
    <value label=Running””>5</value>
    <value label=”Paused”>6</value>
    <value label=”Failure”>8</value>
    <value label=”EndProgrammed”>7</value>
    <value label=”Inert”>129</value>
  </allowed_values>
</statevar>
```

The definition of the action “setHeadingModeComplete0” takes place, for example, as follows:

<action id=”setHeadingModeComplete0”>

<name>Set Heating Mode Complete</name>
<input>

<argument id=”fastPreheating”>
<name>Fast Preheating</name>
<type>java.lang.Boolean</type>
</argument>
<argument id=”heatingModeA”>
<name>Heating Mode</name>
<type>java.lang.Integer</type>
<min>0</min>
<max>21</max>
<step>1</step>
</argument>
<argument id=”targetTempA”>
<name>Target Temp/Setting</name>
<type>java.lang.Integer</type>
<min>0</min>
<max>300</max>
<step>1</step>
</argument>
<argument id=”durationA”>
<name>Duration Time in Minutes</name>
<type>java.lang.Integer</type>
<min>0</min>
<max>1439</max>
<step>1</step>
</argument>
<argument id=”finishTimeA”>
<name>Finish Time in Minutes</name>
<type>java.lang.Integer</type>
<min>0</min>
<max>1439</max>
<step>1</step>
</argument>

</input>

</action>

From the preceding explanations of the software components forming the software module SWM, it should have become clear that in the relevant software module SWM the software-engineered reproduction of the appliance behavior of a real domestic appliance such as the domestic appliance HG shown in the drawing takes place in a model and that this model will be or is described merely declaratively with regard to the appliance parameters defining the respective appliance behavior.

### REFERENCE LIST

CB Control unit architecture bridge

CG Control graph software component

DC Device control software

DI Device information component

DM Device model software module

GW Gateway

HG Domestic appliance

NET Communication network

PC Personal computer

SG State graph software component

SWM Software module

WA Residential complex

1-14. (canceled)

15. A method for software-engineered reproduction of a behavior of an actual domestic appliance in a model, wherein the model is connected to the domestic appliance via a bidirectional connecting device for transmitting current states of the domestic appliance to the model and executing actions on the domestic appliance, the method which comprises:
describing the model merely declaratively by way of graph structures with regard to appliance parameters indicating an appliance behavior;
thereby retaining appliance states and transition conditions between appliance states of the domestic appliance in a status graph software;
checking, by way of control graph software, whether a specific action can be executed in a respective appliance state of the domestic appliance or with specified parameter combinations; and
maintaining in an appliance information software all information on available status variables and actions of the domestic appliance.

16. The method according to claim 15, which comprises implementing the software-engineered reproduction with appliance-specific components and with specifications describing functional properties and, accordingly, the appliance behavior of the domestic appliance under various aspects.

17. The method according to claim 16, which comprises imaging with the specifications logic links of the appliance control of the domestic appliance.

18. A device for software-engineered reproduction of an appliance behavior of an actual domestic appliance in a model, wherein the model is formed between the domestic appliance and a gateway, and the gateway may have a plurality of domestic appliances assigned thereto, comprising:
a connecting device enabling the gateway to interrogate function states of the domestic appliance and/or to transmit information data to the domestic appliance;
wherein the model is merely described declaratively with regard to the appliance parameters indicating the appliance behavior and the model includes:
a first software component to the gateway;
a second software component to the domestic appliance; and
a specification data component between the first and second software components, said specification data component comprising:
a control graph software component enabling a control graph software to check whether a specific action can be executed in a respective state of the domestic appliance or with specified parameter combinations;
an appliance information component; and
a state graph software component.

19. A software module for a software-engineered reproduction of the behavior of an actual domestic appliance in a model, wherein the model is connectable to the domestic appliance via a bi-directional connecting device for transmitting current states of the domestic appliance to the model and for executing actions in the domestic appliance, wherein the model is described merely declaratively by way of graph structures with regard to appliance parameters indicating an appliance behavior, appliance states and transition conditions between appliance states of the domestic appliance are retained in a status graph software, control graph software is configured to enable checking whether a specific action can be executed in the respective state of the domestic appliance or with the specified parameter combinations, and wherein an appliance information software contains all the information on the available status variables and actions of the relevant domestic appliance.

20. The software module according to claim 19, wherein the software-engineered reproduction is implemented by appliance-specific components and by specifications which describe the functional properties and therefore the appliance behavior of the relevant domestic appliance under various aspects.

21. The software module according to claim 20, wherein logic links of the appliance control of the relevant domestic appliance are imaged by way of the specifications.
